(19) United States
(12) Patent Application Publication
(10) Pub. No.: US 2001/0034848 A1
(43) Pub. Date: Oct. 25, 2001

(54) Key card for personal home page access

(76) Inventor: Gail Langley, Blacksburg, VA (US)

Correspondence Address: Lawrence W. Langley, 2733 Big Falls Road, Blacksburg, VA, 24060, US

(21) Appl. No.: 09/781,607

(22) Filed: Feb. 13, 2001

Related U.S. Application Data
(60) Provisional application No. 60/182,573, filed on Feb. 15, 2000.

(51) Int. Cl. H04L 9/32

(52) U.S. Cl. 713/202

(57) ABSTRACT

This invention comprises a method and apparatus for authorizing, initiating and directing the transmission of data over the Internet from outside sources to a personal data base. According to the invention, an individual or family having a personal home page and desiring to maintain it as a private data base will have an access control card, or key card. The key card contains information in a form that is suitable for scanning by optical, electromagnetic or other retrieval means. The code includes the Internet address, and may include an authorization code for its owner's personal home page. In addition the owner may have a password for greater security of data access control. The purpose of the key card is to facilitate, control and direct transmission of data to the personal home page, limiting access to authorized sources.

### BACKGROUND

This invention comprises a method and apparatus for authorizing, initiating and directing the transmission of data over the Internet from outside sources to a personal data base.

As the Internet becomes an ever more popular and effective advertising medium, the amount of unwanted information transmitted to every user increases, seemingly without limit. While most advertisers on the Internet attempt to direct their messages to those who might actually be interested in the subject matter, many do not, and this results in a large number of unwanted messages, or “spam” for the typical user. Since it is almost impossible to prevent one's e-mail address from being propagated on the net, an alternative and more effective way of selecting sources and types of messages is needed.

Criminals and mischief-makers make the commercial and private uses of the Internet 2% increasingly hazardous. Theft and unauthorized use of information are growing as rapidly as the legitimate uses of the Internet. Without some mechanism for increasing the privacy of Internet use, many desirable applications may be impossible to establish and justify.

With the current state of the art, one might try to create a private home page, accessible only to authorized sources of data, by keeping the IP address confidential. However, this is not practical because all nodes of the Internet must have a routing for any address so that messages can be properly channelled by the first available open routing. Unwanted messages would have to be intercepted at the receiving server. This requires an authorization code or password that is known only to authorized sources of data.

It would be possible to establish a private home page on a server with, in effect, a password for acceptance of messages. However, the password would have to be revealed to all desired sources of information, to allow them to transmit messages to the private home page. This would require a data base of Internet addresses and passwords to be kept by each authorized source. This data base would have to be maintained with all possible changes - users being added and removed, passwords being compromised, changing and becoming obsolete over time. The administration of such a data base would be extremely complex.

An alternative would be for each user having a private home page to authorize a data source pro tem by entering address and password information in a keyboard. This would be arduous and prone to errors. The password would have to be unique for all possible users. There would be a strong temptation to write down the password, creating a risk of discovery by unauthorized persons.

### THE INVENTION

According to the invention, an individual or family having a personal home page and desiring to maintain it as a private data base will have an access control card, or key card. The key card contains information in a form that is suitable for scanning by optical, electromagnetic or other retrieval means. The code includes the Internet address, and may include an authorization code for its owner's personal home page. In addition the owner may have a password for greater security of data access control. The purpose of the key card is to facilitate, control and direct transmission of data to the personal home page, limiting access to authorized sources. The card may also have an Internet address for ordinary e-mail messages, but this address would only be used for ordinary text transmissions such as advertising messages.

The uses of the key card and its advantages are best described by examples. The consumer takes the key card to a grocery store. At check-out the consumer swipes the key card using a terminal in the check-out lane, and enters the password. In response to this input the grocery store computer will contact the consumer's home page on the Internet and download data to it about the purchases the consumer has made. The data sent may include bar codes, item descriptions, sizes or amounts, prices, expiration dates, and nutritional data. All this data is stored by the consumer's home page server or computer.

If either the authorization code in the key card or the password entered by the consumer is invalid, data will not be forwarded to the home page server and the key card owner will be notified. Optionally, a message may be sent to the home page server indicating the unsuccessful attempt at access.

Actual transmission to the consumer's server buffer by the grocery store computer could be deferred until a later time, and the data would then be sent as part of a batch.

In another scenario, the consumer takes the key to a doctor's appointment. After the visit or examination, the consumer scans the card in a terminal in the doctor's office and enters the password. This causes transmission of prescriptions, physician's comments and recommendations, future appointments and other health related data to the personal home page.

At any time the consumer may access the personal home page from a home computer or other secure site, and selectively download data from the receiving buffer into a personal data base. When this is done, the data is removed from the buffer section of the server, and put into the consumer's personal data base.

A purpose of the invention is to enable users to acquire data in a secure manner about their activities outside the home, and store it in a private data base without having to write it down or carry it in documents. The amount of data acquired in connection with a transaction can be all-inclusive. For example, the data may include everything on the label of a purchased article, but in a machine-readible form that can be better utilized by the consumer.

A second purpose of the invention is to provide convenient and secure access to a private data base on the Internet from a user's remote location, without requiring written numbers or memorization of a long password.

Another function of the key card may be to allow the retailer or other data source to download advertising or promotional data to the user at other times, subject to an arrangement with the key card holder. For example, a grocery store could send announcements of special prices or seasonal items, directing these messages to actual customers. This type of advertising is much more effective than newspaper, radio, television, etc. It can be the modern analog of the family butcher calling customers to tell them that he has a particularly nice cut of meat.

Data sent from all remote locations to the personal home page is preferably in a format that will allow it to be selectively merged into the personal data base.

Some other data sources that might be authorized by a key card to send data to a personal home page in this manner are the public library, video rental store, pharmacy, dentist, schools, clubs and civic organizations. Alternatively, the key card data could be imbedded in a credit card, and used to signal purchases or unauthorized attempts to the user's home page.

In order for the system of the invention to work, it must have an economic basis. Capital and other costs for the servers and software would have to be paid for by subscriptions and fees. These could come from users, stores and manufacturers. With many sources of support the cost to any one user would be minimal.

For security of the data in each user's home page and data base, data encryption may be employed. The key card could contain the encryption parameters as well as the home page address. Encryption could be used for all transmissions or only for those containing sensitive data. Provisions would have to be made to prevent authorized data sources from copying either the encryption parameters or the authorization code.

### THE PREFERRED EMBODIMENT OF THE INVENTION

The key card of the invention is a plastic card similar to a credit card, with a magnetic stripe containing encoded data. When the data in the card is read by a magnetic scanner at an authorized site, it can only be interpreted with the aid of a password. The password is entered by the card owner in a keyboard that is located near the magnetic scanner at the site. When the data in the card is interpreted using the password, it is then used to access the card owner's internet connection, for the purpose of secure and private communications. The card owner's IP address and an authorization code are transmitted over the Internet to establish a connection for transmittal of private data to the card owner's home computer.

The invention includes software in the card owner's server that compares the data sent from the key card to a locally stored authorization code. If there is a match, the server will allow data to be down-loaded from the site of the magnetic scanner and keyboard.

The invention also includes a card reader and keyboard at locations which may be authorized to send data according to the invention. The card reader is adapted to reading the code in the key card, receiving the password as it is entered in the keyboard, and interpreting or decrypting the Internet address and authorization code for transmission over the Internet.

### VARIATIONS OF THE INVENTION

The key card may contain data in the form of a magnetic stripe or optical pattern similar to a Universal Product Code, or in any other form that can be scanned easily by the holder. The data may be encrypted using the password to prevent use of the card by a person who does not know the password. The key card may also contain information about the identity of the owner, which will allow verification by persons at the site from which data will be transmitted over the net.

Software for authorization may be located in the server used by the card key owner, or in another computer that contains the card key owner's personal data base. The authorization software may transmit a message or messages over the Internet to the site where the card has been read, to verify that data will be accepted and stored in the card key owner's data base. The authorization software may also send a message or messages over the Internet to indicate that the data will not be accepted. Reasons for non-acceptance may be that the authorization code is incorrect, or that no storage is available, or that the source is not on an approved list, or that the data base cannot interpret data from that source.

The key card reader at sites which may originate data according to the invention may be any type of reader adapted to reading the data in the key card. The card may be read by passing it through an aperture or slot or by holding it motionless in front of a scanner. Data may be derived from the card by any appropriate form of electromagnetic radiation, either actively or passively. Data may also be stored in the card by the reader.

The keyboard at sites that may originate data can be a numeric keypad or alphanumeric type, or one with a special key layout designed for use with the key card. Data entered in the keyboard may include the password and the key card owner's choices of functions. For example, the key card owner may choose among options for transmittal of data, such as prices only, or other selections of data. The choices may be presented to the key card owner in a display associated closely with the keyboard and the card reader.

Data transmitted over the Internet according to the invention may consist of any of the following:

identities and due dates for books, tapes or other borrowed items;

medicines or drugs prescribed by a physician, including dosage and term;

appointments for medical, dental, veterinary and other services;

instructions and warnings for medicines and drugs obtained from a pharmacy;

scores from sporting events in which the card key owner is a participant;

banking transactions;

credit card transactions;

identities and prices of groceries and other purchased items;

travel plans including reservations, itinerary, and dates; and

nutritional data and suggested recipes for groceries purchased.

For the data transmitted to the card owner's data base to be useful, it must be in a format that is readily accessed and understood by the card owner. The format for data from different sources may be the same or different, and any data organization may be used for convenience. In retrieving and using the data, the card owner may use any data base system, spreadsheet or word processor.

### EXAMPLE USES OF DATA SENT WITH KEY CARD AUTHORIZATION

The data sent to a key card owner's data base may be used in many ways. For example, information about purchases in a grocery store could be used to create an inventory of foods on hand in the home. With appropriate software for home data base management, the inventory could be scanned for items which are approaching their expiration dates, or recipes could be suggested that use only ingredients on hand. If a scanner or other data entry method is available in the home, the inventory could be corrected whenever a food item is removed or used. When a shopping trip is planned, the inventory could be scanned for items that are below a minimum quantity, and added to the grocery list. Thus the key card enables the consumer to maintain a data base of foodstuffs that will not contain unwanted data.

Data sent over the Internet about books and other items borrowed by the key card owner from the library could be used to issue reminders of due dates. It could be used to create and maintain a list of books that have been read or video tapes that have been viewed.

Data sent by a physician or dentist following an examination could include reminders for the patient, warnings about possible side-effects of treatment or drugs prescribed, results of diagnostic tests, etc., all of which should be stored in durable form.

I claim:

1. A system for enabling and controlling remote access for data entry into a personal data base comprising:
an authorization code stored in said personal data base;
a key card containing said authorization code and the address of said data base;
means for scanning and reading said address and said authorization code at a remote source of data; and
means for transmitting data from said remote source of data into said personal data base when said authorization code in said card matches said authorization code stored in said data base.

2. The system of claim 1 in which said means for transmitting data is the Internet and said address is the IP address of said data base.

3. The system of claim 2 further comprising means for employing a password to control use of said card.

4. The system of claim 3 further comprising means for encrypting said authorization code and said address in said card using said password; and
means for employing said password to decrypt said authorization code and said address.

5. The system of claim 4 in which said means for employing said password includes a keyboard.
